(19) United States
(12) Patent Application Publication
(10) Pub. No.: US 2007/0275743 A1
(43) Pub. Date: Nov. 29, 2007

(54) System and Method for Emergency Notification

(75) Inventor: Robert C. Lovell, Leesburg, VA (US)

Correspondence Address: EDELL, SHAPIRO & FINNAN, LLC, 1901 RESEARCH BOULEVARD, SUITE 400, ROCKVILLE, MD, 20850, US

(73) Assignee: Sybase 365, Inc., Chantilly, VA (US)

(21) Appl. No.: 11/746,982

(22) Filed: May 10, 2007

Related U.S. Application Data
(60) Provisional application No. 60/802,766, filed on May 24, 2006.

(51) Int. Cl. H04Q 7/20

(52) U.S. Cl. 455/466

(57) ABSTRACT

A service that leverages established wireless messaging paradigms such as, possibly inter alia, Short Message Service, Multimedia Message Service, and IP Multimedia Subsystem to yield an infrastructure that synergistically provides, possibly inter alia, (1) a full-featured alternative (e.g., non-voice telephone call) emergency notification, reporting, etc. channel that (2) works across (i.e., provides ubiquitous access to) the full universe of Wireless Devices that are carried by Mobile Subscribers. The service may optionally leverage the capabilities of a Value-Added Service Provider.

This application claims the benefit of U.S. Provisional Patent Application No. 60/802,766, filed on May 24, 2006, which is herein incorporated by reference in its entirety.

### BACKGROUND

1. Field of the Invention

The present invention relates generally to telecommunications services. More particularly, the present invention relates to capabilities that enhance substantially the value and usefulness of various wireless messaging paradigms including, inter alia, Short Message Service (SMS), Multimedia Message Service (MMS), IP Multimedia Subsystem (IMS), etc.

2. Background of the Invention

As the ‘wireless revolution’ continues to march forward the importance to a Mobile Subscriber (MS), for example a user of a Wireless Device (WD) such as a mobile telephone, BlackBerry, etc. that is serviced by a Wireless Carrier (WC), of their WD grows substantially. One consequence of such a growing importance is the resulting ubiquitous nature of WDs—i.e., MSs carry them at almost all times.

Concurrent with the positive progress that the ‘wireless revolution’ has enjoyed society has, sadly, suffered significant negative progress. Among other things, we live in an increasingly more dangerous and violent environment—e.g., pervasive street crime, terrorism, domestic violence, gang activities, aggressive drivers, etc.

The ubiquitous nature of MS' WDs provide an excellent vehicle for the immediate reporting of emergency situations through a voice telephone call (to, for example, emergency response numbers such as 911 in the United States and 999 in the United Kingdom).

However, there are occasions when completing such a voice telephone call may be problematic—e.g., when voice circuits are busy or otherwise unavailable (such as during a large-scale crisis or emergency situation).

Additionally, there are occasions when a voice telephone call may not be fully adequate—e.g., when it is desirous to capture and preserve some piece of textual or visual information (through, as just one example, a picture or a video clip taken by a camera-enabled WD). For purposes of illustration consider just a few simple examples:

1) A witness to an accident would like to capture one or more pictures of the accident scene (through, for example, their camera-enabled WD).

2) A witness to a hit-and-run incident would like to capture the license plate of the offending vehicle (through, for example, an SMS message and/or a picture on their WD).

3) A bystander observes a person behaving suspiciously (at, for example, a large public gathering) and would like to capture one or more pictures or a video clip of the individual (through, for example, their camera-enabled WD).

4) A witness to an incident of aggressive, erratic or unsafe, etc. driving would like to capture one or more details (e.g., the license plate, if applicable the corporate logo and identification number, etc.) concerning the offending vehicle (through, for example, an SMS message and/or a picture on their WD).

5) A driver notices a vehicle that matches a description that was provided in an announced Amber Alert would like to capture details (e.g., the license plate, location and direction of travel, etc.) about the vehicle (through, for example, an SMS message on their WD).

The examples that were presented above, and the advantages that arise from same, are illustrative only and it will be readily apparent to one of ordinary skill in the relevant art that numerous other examples, and associated advantages, are easily possible.

What is desirable is an infrastructure that synergistically provides, possibly inter alia, (1) a full-featured alternative (e.g., non-voice telephone call) emergency notification, reporting, etc. channel that (2) works across (i.e., provides ubiquitous access to) the full universe of MS' WDs.

The present invention extends key elements of wireless messaging technology to yield such an infrastructure—i.e., facilities that provide MSs with an alternative (e.g., non-voice telephone call) channel through which they can use their WDs to easily report information about emergency situations, etc.- and addresses various of the (not insubstantial) challenges that are associated with same.

### SUMMARY OF THE INVENTION

Embodiments of the present invention provide an alternative (e.g., non-voice telephone call) mechanism through which a MS can use their WDs to easily report information about emergency situations, etc.

In one embodiment a method for emergency notification includes receiving from a WD of a MS a notification message indicative of an emergency condition; performing one or more processing steps on the notification message yielding a processed notification message; and generating one or more responses in view of the processed notification message.

In an aspect of this and other embodiments the notification messages may include, possibly inter alia, SMS, MMS, and/or IMS messages; may be directed to a Short Code (SC), a Telephone Number (TN), and/or a Session Initiation Protocol (SIP) Uniform Resource Identifier (URI); and may contain some combination of graphic elements (e.g., such as a picture or a video clip) and/or textual elements.

In another aspect of this and other embodiments the processing steps may include, possibly inter alia, one or more of (as described below) Data Value Extraction, Validation and Editing, Enhancement and Augmentation, Analysis, and Action.

In another aspect of this and other embodiments the generated responses may consist of, possibly inter alia, alerting one or more third-parties (such as, for example, law enforcement agencies) and/or dispatching one or more reply (SMS, MMS, IMS, etc.) messages to the originating MS.

More specifically, there is provided a method for emergency notification, that includes receiving from a Wireless Device of a Mobile Subscriber a notification message indicative of an emergency condition, situation or event, and determining a location from which the notification message was sent and/or a nature of the emergency condition situation or event. Then, based on the foregoing, the method includes identifying an appropriate (local) authority to receive the notification message, and thereafter sending the notification message to the appropriate authority, such that an appropriate emergency response can follow. The authority may include, among others, the fire department and law enforcement.

In accordance with one implementation, multiple notification messages are received from mobile subscribers, and the notification messages are thereafter compared to confirm the nature of a situation or, perhaps combined to obtain a better overall understanding of the nature of the situation. Only after such confirmation or receipt of additional information, for example, is an alert message dispatched to the appropriate authorities.

In still another implementation, the mobile subscriber that submits the notification message is awarded a reward. Such an award may be awarded after the capture or conviction of a criminal, or where it is determined that the timely submitted notification message saved people or property. Such awards would then provide incentives to mobile subscribers to submit relevant notification messages. Of course, mobile subscribers who might tend to abuse the ability to send such notifications messages may be blacklisted or even fined, if the abuse is severe.

These and other features of the embodiments of the present invention along with their attendant advantages will be more fully appreciated upon a reading of the following detailed description in conjunction with the associated drawings.

### BRIEF DESCRIPTION OF THE DRAWINGS

FIG. 1 is a diagrammatic presentation of an exemplary Value-Added Service Provider (VASP).

FIG. 2 illustrates various of the exchanges or interactions that are supported by aspects of the present invention.

FIG. 3 is a diagrammatic presentation of aspects of an exemplary Service Provider (SP) Application Server (AS).

### DETAILED DESCRIPTION OF THE INVENTION

Embodiments of the present invention may leverage the capabilities of a centrally-located, full-featured VASP facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a VASP, a summary of various of the services/functions/etc. that are performed by a VASP, and a discussion of the numerous advantages that arise from same.

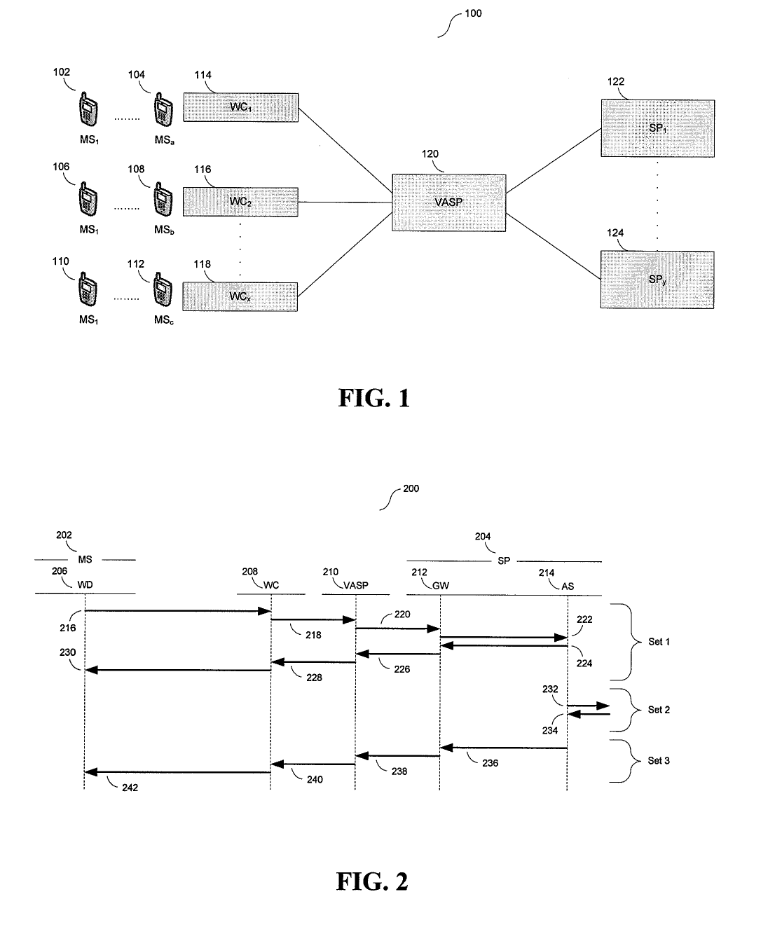

As depicted in FIG. 1 and shown generally by reference numeral 100, a VASP 120 may be disposed between, possibly inter alia, multiple WCs (WC₁ 114→WCₓ 118) on one side and multiple SPs (SP₁ 122→SP_{y} 124) on the other side thus ‘bridging’ all of the connected entities. A VASP 120 thus, as one simple example, may offer various routing, formatting, delivery, value-add, etc. capabilities that provide, possibly inter alia:

1) A WC 114→118 (and, by extension, all of the MSs 102→104, 106→108, 110→112 that are serviced by the WC 114→118) with ubiquitous access to a broad universe of SPs 122→124, and

2) A SP 122→124 with ubiquitous access to a broad universe of WCs 114→118 (and, by extension, to all of the MSs 102→104, 106→108, 110→112 that are serviced by the WCs 114→118).

Generally speaking a VASP may have varying degrees of visibility (e.g., access, etc.) to the (MS←→MS, MS←→SP, etc.) messaging traffic:

1) A WC may elect to route just their out-of-network messaging traffic to a VASP. Under this approach the VASP would have visibility (e.g., access, etc.) to just the portion of the WC's messaging traffic that was directed to the VASP by the WC.

2) A WC may elect to route all of their messaging traffic to a VASP. The VASP may, possibly among other things, subsequently return to the WC that portion of the messaging traffic that belongs to (i.e., that is destined for a MS of) the WC. Under this approach the VASP would have visibility (e.g., access, etc.) to all of the WC's messaging traffic.

While the discussion below will include a VASP, it will be readily apparent to one of ordinary skill in the relevant art that other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a VASP, multiple third-party entities working together, etc.

In the discussion below reference is made to messages that are sent, for example, between a MS and a SP. As set forth below, a given ‘message’ sent between a MS and a SP may actually comprise a series of steps in which the message is received, forwarded and routed between different entities, including possibly inter alia a MS, a WC, a VASP, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a VASP; a VASP and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

To better understand the particulars of the present invention consider for a moment a simple hypothetical example—SP SPₓ offers a service that has been enhanced or augmented as provided through aspects of the instant invention and Mary, a MS, uses SPₓ's service.

FIG. 2 and reference numeral 200 illustrate various of the exchanges or interactions that might occur under a portion of our hypothetical example. Of interest and note in the diagram are the following entities:

1) MS 202 WD 206. For example, Mary's WD such as a mobile telephone, BlackBerry, PalmPilot, etc.

2) WC 208. The provider of service for Mary's 202 WD 206.

3) VASP 210. As noted above the use of a VASP, although not required, provides significant advantages.

SP 204 Gateway (GW) 212. A messaging, etc. gateway facility within SPₓ 204.

SP 204 AS 214. Facilities within SPₓ 204 that provide key elements of the instant invention (which will be described below).

It is important to note or observe that:

1) In the instant example the messages are shown traversing a VASP.

2) The SP may employ a Short Code (SC) or a regular Telephone Number (TN) as its source address (and to which it would ask users of its service to direct any messages). While the abbreviated length of a SC (e.g., five digits for a SC administered by Neustar under the Common Short Code [CSC] program) incrementally enhances the experience of a MS (e.g., the MS need remember and enter only a few digits as the destination address of a message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY,” which is incorporated herein by reference. As just one example, following the model that is employed in the UK (where emergency voice telephone calls may be directed to 999) a SP might offer the instant invention under the CSC 99999.

In FIG. 2 the exchanges that are collected under the designation Set 1 represent the activities that might take place as Mary 202 submits an SMS/MMS/IMS/etc. message in accordance with aspects of the present invention. For example (using an illustrative hypothetical):

1) Mary 202 witnesses a hit-and-run accident, uses her WD 206 to capture a photograph of the offending vehicle's license plate, and (perhaps after being unable to call 911 to report the incident) dispatches an SMS/MMS/IMS/etc. message 216 to CSC 99999. Such a message may also be referred to herein as a “notification message.”

2) The WC 208 that services Mary's 202 WD 206 receives the message, identifies the message as having a destination address of CSC 99999, and routes the message 218 on to a VASP for further routing, processing, and delivery.

3) The VASP 210 receives the message, identifies the message as having a destination address of CSC 99999, and routes the message 220 on to the (appropriate) destination SP, SPX 204 (i.e., the SP that currently services the CSC 99999).

4) A GW 212 at SPX 204 receives the message, optionally performs one or more processing steps (described below), and passes the message 222 on to an available AS 214.

5) The AS receives the message, performs a series of processing steps (described below), and possibly, inter alia, dispatches one or more SMS/MMS/IMS/etc. reply messages 224 (which, in brief, traverses a reverse path of the above 226→230) to Mary's 204 WD 206.

As indicated above, a SP's GW and AS may, individually and/or together, perform a range of processing steps. The processing steps may include, possibly inter alia:

1) Data Value Extraction. A range of data values may be extracted or retrieved from an incoming message including, inter alia, date and time, the TN of the sending MS, possibly the physical location of the sending MS, the body or content of the message, etc. The specific data values that were just cataloged are illustrative only and it will be readily apparent to one of ordinary skill in the relevant art that numerous other pieces of information are easily possible and indeed are fully within the scope of the present invention.

2) Validation and Editing. A flexible, extensible, and dynamically configurable set of validation, edit, etc. rules may optionally be applied to one or more of the data values.

3) Enhancement and Augmentation. One or more flexible, extensible, and dynamically configurable operations may optionally be completed against one or more of the data values to enhance or augment those data values and/or derive other data values. For example:

(a) Using the TN of the sending MS and a comprehensive number lookup facility (that, among other things, fully supports Mobile Number Portability [MNP] schemes) the identity of the specific WC that services the MS may be determined.

(b) If it was not possible to obtain the current physical location of the sending MS directly from the incoming message one or more operations may optionally be completed against the Location-Based Services (LBS), Global Positioning System (GPS), etc. capabilities/facilities of the servicing WC to obtain the current physical location of the sending MS.

(c) One or more of the available data elements may optionally be leveraged to identify the specific law enforcement, fire and rescue, etc. resources that are at or near the MS' current physical location.

The specific enhancement and augmentation operations that were just cataloged are illustrative only and it will be readily apparent to one of ordinary skill in the relevant art that numerous other operations are easily possible and indeed are fully within the scope of the present invention.

4) Analysis. One or more flexible, extensible, and dynamically configurable manual (e.g., human intervention) and/or automated (e.g., pattern-recognition software) analysis operations may optionally be completed. For example:

(a) One or more third-party telephone directory, license plate number, watch list, etc. databases may be queried.

(b) One or more data values (or images) from an incoming message may be compared to, correlated with, etc. one or more data values (or images) from previously-received messages to, for example, identify or further develop one or more patterns, confirm the nature of a possible emergency, event or situation, or obtain additional information with respect to the same emergency, event or situation.

The analysis operations that were described above are illustrative only and it will be readily apparent to one of ordinary skill in the relevant art that numerous other analysis operations are easily possible.

5) Action. Based on (i) a flexible, extensible, and dynamically configurable set of action rules and (ii) various of the data values, analysis results, etc. one or more actions may optionally be executed. For example:

(a) An incoming message, possibly along with other developed information, may be forwarded to a local law enforcement agency.

(b) A local law enforcement agency may be contacted (e.g., called) directly.

(c) One or more SMS/MMS/IMS/etc. reply messages may be dispatched to the sending MS with a request for additional information.

(d) One or more SMS/MMS/IMS/etc. reply messages may be dispatched to the sending MS with a request that the MS contact (e.g., call) a specific third-party (e.g., a law enforcement agency) using a provided TN.

(e) An incoming message, possibly along with other developed information, may be forwarded to one or more national agencies (e.g., the Federal Bureau of Investigation [FBI], the Department of Homeland Security [DHS], etc.).

(f) One or more national agencies (e.g., the FBI, the DHS, etc.) may be contacted (e.g., called) directly.

The actions that were described above are illustrative only and it will be readily apparent to one of ordinary skill in the relevant art that numerous other actions are easily possible.

The specific exchanges that were described above (as residing under the designation Set 1) are illustrative only and it will be readily apparent to one of ordinary skill in the relevant art that numerous other exchanges are easily possible and indeed are fully within the scope of the present invention.

In FIG. 2 the exchanges that are collected under the designation Set 2 represent the activities that might take place as SPX's 204 AS 214 optionally completes one or more exchanges, interactions, lookup operations, etc. with one or more third-parties 232→234. For example, one or more third-party license plate number, watch list, etc. databases may optionally be queried and/or updated; one or more messages, calls, etc. may be exchanged with third-party agencies (e.g., local law enforcement, local fire and rescue, the FBI, the DHS, etc.); etc.

The specific exchanges that were described above (as residing under the designation Set 2) are illustrative only and it will be readily apparent to one of ordinary skill in the relevant art that numerous other exchanges are easily possible and indeed are fully within the scope of the present invention.

In FIG. 2 the exchanges that are collected under the designation Set 3 represent the activities that might take place as SPX 204 optionally dispatches one or more additional SMS/MMS/IMS/etc. reply messages 236 to Mary 202. Such reply messages would, as described above, traverse the reverse path SP 204→VASP 210→WC 208→MS 202 (as depicted by 238→242). Such reply messages might contain, for example, further updates or status reports, further requests for additional information (that might then result in still further message exchanges), etc.

The specific exchanges that were described above (as residing under the designation Set 3) are illustrative only and it will be readily apparent to one of ordinary skill in the relevant art that numerous other exchanges are easily possible and indeed are fully within the scope of the present invention.

The Set 1, Set 2, and Set 3 exchanges that were described above are illustrative only and it will be readily apparent to one of ordinary skill in the relevant art that numerous other exchanges are easily possible and indeed are fully within the scope of the present invention. For example:

1) A SP may offer an optional registration process. A registration process may be tailored (e.g., the range of information gathered, the scope of access subsequently granted, etc.) to the class of user—e.g., different types, categories, etc. of users may complete different registration processes. A registration process may be completed through any combination of one or more channels including, inter alia, the World Wide Web (WWW via, for example, a Web site that is operated by SPₓ), wireless messaging (SMS, MMS, etc.), Electronic Mail (E-Mail) messages, Instant Messaging (IM), conventional mail, telephone, Interactive Voice Response (IVR) facility, etc. Information that may be collected during a registration process may be preserved in a data repository (e.g., a database) and may optionally be organized as a Profile. A Profile may optionally be augmented by a SP to include, as just a few examples of the many possibilities, internal and/or external demographic, psychographic, sociological, etc. data.

2) A SP may provide support for a range of billing models including, inter alia, a fixed one-time charge, a recurring (monthly, etc.) fixed charge, a recurring (monthly, etc.) variable charge, etc. A SP may offer different payment mechanisms including, possibly among other things, credit or debit card information, authorization to place a charge on a MS's phone bill, etc. A billing transaction may take any number of forms and may involve different external entities (e.g., a WC's billing system, a carrier billing system service bureau, a credit or debit card clearinghouse, etc.). A billing transaction may include, inter alia:

A) The appearance of a line item charge on the bill or statement that a MS receives from her WC. Exemplary mechanics and logistics associated with this approach are described in pending U.S. patent application Ser. No. 10/837,695 entitled “SYSTEM AND METHOD FOR BILLING AUGMENTATION,” which is incorporated herein by reference. Other ways of completing or performing line item billing are easily implemented by those skilled in the art.

B) The charging of a credit card or the debiting of a debit card.

The reply message(s) that were described above may optionally contain an informational element—e.g., a public service announcement, a relevant or applicable personal or physical safety factoid, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a LBS facility).

The reply message(s) may optionally contain advertising—e.g., textual material if an SMS model is being utilized, multimedia (images of brand logos, sound, video snippets, etc.) material if an MMS model is being utilized, etc. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a LBS facility).

The reply message(s) may optionally contain promotional materials (e.g., text, still images, video clips, etc.).

In one possible implementation of the present invention, MS 202 may be given an award (e.g., monetary, etc.) in connection with submission of a (notification) message 216 that leads to, e.g., the capture or arrest of a criminal, the avoidance of an accident, the timely reporting of a fire, etc.

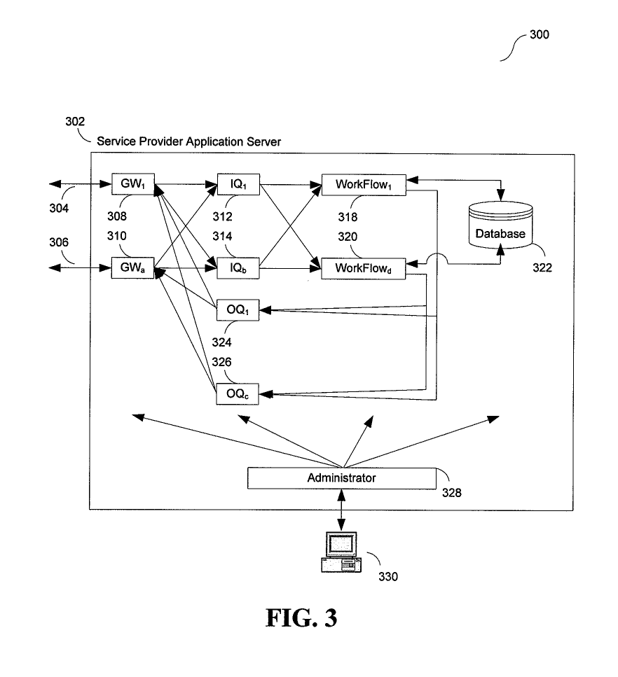

FIG. 3 and reference numeral 300 provide a diagrammatic presentation of aspects of an exemplary SP AS 302. The illustrated AS 302 contains several key components—Gateways (GW₁ 308→GWₐ 310 in the diagram), Incoming Queues (IQ₁ 312→IQ_{b} 314 in the diagram), WorkFlows (WorkFlow₁ 318→WorkFlow_{d} 320 in the diagram), Database 322, Outgoing Queues (OQ₁ 324→OQ_{c} 326 in the diagram), and an Administrator 328. It will be readily apparent to one of ordinary skill in the relevant art that numerous other components are possible within an AS 302.

A dynamically updateable set of one or more Gateways (GW₁ 308→GWₐ 310 in the diagram) handle incoming (e.g., SMS/MMS/IMS/etc. messaging, etc.) traffic and outgoing (e.g., SMS/MMS/IMS/etc. messaging, etc.) traffic. Incoming traffic is accepted and deposited on an intermediate or temporary Incoming Queue (IQ₁ 312→IQ_{b} 314 in the diagram) for subsequent processing. Processed artifacts are removed from an intermediate or temporary Outgoing Queue (OQ₁ 324→OQ_{c} 326 in the diagram) and then dispatched.

A dynamically updateable set of one or more Incoming Queues (IQ₁ 312→IQ_{b} 314 in the diagram) and a dynamically updateable set of one or more Outgoing Queues (OQ₁ 324→OQ_{c} 326 in the diagram) operate as intermediate or temporary buffers for incoming and outgoing traffic.

A dynamically updateable set of one or more WorkFlows (WorkFlow₁ 318→WorkFlow_{d} 320 in the diagram) remove incoming traffic from an intermediate or temporary Incoming Queue (IQ₁ 312→IQ_{b} 314 in the diagram), perform all of the required processing operations, and deposit processed artifacts on an intermediate or temporary Outgoing Queue (OQ₁ 324→OQ_{c} 326 in the diagram).

The Database 322 that is depicted in FIG. 3 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

As depicted in FIG. 3 an Administrator 328 provides management or administrative control over all of the different components of an AS 302 through, as one example, a WWW-based interface 330. It will be readily apparent to one of ordinary skill in the relevant art that numerous other interfaces (e.g., a data feed, etc.) are easily possible.

Through flexible, extensible, and dynamically updatable configuration information, a WorkFlow component may be quickly and easily realized to support any number of activities. For example, WorkFlows might be configured to support the extraction of data values from an incoming message; the editing/validation of data values; the enhancement/augmentation of data values; an array of analysis operations; an array of actions; the generation and dispatch of reply messages; the generation of scheduled and/or on-demand reports; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, messaging, etc. activities may be recorded. Among other things, such a repository may be used to support:

1) Scheduled (e.g., daily, weekly, etc.) and/or on-demand reporting with report results delivered (to, e.g., local law enforcement agencies, national agencies such as the FBI or the DHS, etc.) through SMS, MMS, IMS, etc. messages; through e-mail; through a WWW-based facility; etc.

2) Scheduled and/or on-demand data mining initiatives (possibly leveraging or otherwise incorporating one or more external data sources) with the results of same presented through Geographic Information Systems (GISs), visualization, etc. facilities and delivered (to, e.g., local law enforcement agencies, national agencies such as the FBI or the DHS, etc.) through SMS, MMS, IMS, etc. messages; through e-mail; through a WWW-based facility; etc.

It is important to note that while aspects of the discussion that was presented above focused on the use of SCs, it will be readily apparent to one of ordinary skill in the relevant art that TNs and other message address identifiers (such as, for example, SIP URIs) are equally applicable and, indeed, are fully within the scope of the present invention.

The discussion that was just presented referenced the specific wireless messaging paradigms SMS and MMS. These paradigms potentially offer an incremental advantage over other paradigms in that native support may commonly be found on a WD that a potential MS would be carrying. However, it is to be understood that it would be readily apparent to one of ordinary skill in the relevant art that other paradigms (IMS, etc.) are fully within the scope of the present invention.

It is important to note that the hypothetical example that was presented above, which was described in the narrative and which was illustrated in the accompanying figures, is exemplary only. It will be readily apparent to one of ordinary skill in the relevant art that numerous alternatives to the presented example are easily possible and, indeed, are fully within the scope of the present invention.

The following list defines acronyms as used in this disclosure.

| Acronym | Meaning |
|---|---|
| AS | Application Server |
| CSC | Common Short Code |
| DBMS | Database Management System |
| DHS | Department of Homeland Security |
| E-Mail | Electronic Mail |
| FBI | Federal Bureau of Investigation |
| GIS | Geographic Information System |
| GPS | Global Positioning System |
| GW | Gateway |
| IM | Instant Messaging |
| IMS | IP Multimedia Subsystem |
| IQ | Incoming Queue |
| IVR | Interactive Voice Response |
| LBS | Location Based Services |
| MMS | Multimedia Message Service |
| MNP | Mobile Number Portability |
| MS | Mobile Subscriber |
| ODBMS | Object Database Management System |
| OQ | Outgoing Queue |
| RDBMS | Relational Database Management System |
| SC | Short Code |
| SIP | Session Initiation Protocol |
| SMS | Short Message Service |
| SP | Service Provider |
| TN | Telephone Number |
| URI | Uniform Resource Identifier |
| VASP | Value-Added Service Provider |
| WC | Wireless Carrier |
| WD | Wireless Device |
| WWW | World Wide Web |

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the relevant art in light of the above disclosure.

What is claimed is:

1. A method for emergency notification, comprising:
receiving from a Wireless Device of a Mobile Subscriber a notification message indicative of an emergency condition;
determining a location from which the notification message was sent;
based, at least in part, on the location from which the notification message was sent, identifying an appropriate authority to receive the notification message; and
sending the notification message to the appropriate authority.

2. The method of claim 1, wherein the notification message is a SMS message.

3. The method of claim 1, wherein the notification message is a MMS message.

4. The method of claim 1, wherein the notification message is an IMS message.

5. The method of claim 1, wherein the notification message is addressed by the Mobile Subscriber to a Short Code.

6. The method of claim 1, wherein the notification message is addressed by the Mobile Subscriber to a Telephone Number.

7. The method of claim 1, wherein the notification message is directed to a SIP URI.

8. The method of claim 1, wherein the notification message contains one or more textual elements.

9. The method of claim 1, wherein the notification message contains one or more graphic elements.

10. The method of claim 9, wherein the graphic element is a photograph.

11. The method of claim 9, wherein the graphic element is a video clip.

12. The method of claim 1, further comprising receiving the location from a wireless carrier of the Mobile Subscriber.

13. The method of claim 1, wherein the appropriate authority is a law enforcement authority.

14. The method of claim 1, further comprising comparing the notification message with at least one other previously-received notification message.

15. The method of claim 14, further comprising determining whether a pattern exists among the notification message and the at least one other previously-received notification message.

16. The method of claim 1, further comprising registering the Mobile Subscriber prior to the step of receiving.

17. The method of claim 1, further comprising replying to the Mobile Subscriber with a reply message.

18. The method of claim 17, wherein the reply message comprises advertising and/or promotional material.

19. The method of claim 17, wherein the reply message is a SMS message.

20. The method of claim 17, wherein the reply message is a MMS message.

21. The method of claim 1, further comprising awarding a reward to the Mobile Subscriber for submitting the notification message.

22. A method for emergency notification, comprising:
receiving from a Wireless Device of a Mobile Subscriber a notification message indicative of an emergency;
determining a nature of the emergency based on the notification message;
comparing the notification message to at least one other previously-received notification message to confirm the nature of the emergency; and
sending an alert message to an appropriate authority that addresses emergencies of a same type as the nature of the emergency.

23. The method of claim 22, wherein the notification message includes an image.

24. The method of claim 22, wherein the emergency comprises a fire.

25. The method of claim 22, wherein the emergency comprises an identification of a vehicle.

26. The method of claim 22, wherein the appropriate authority is a law enforcement authority.

27. The method of claim 22, further comprising awarding a reward to the Mobile Subscriber for submitting the notification message.

28. A method for alerting appropriate local authorities, comprising:
receiving from a Wireless Device of a Mobile Subscriber a notification message indicative of a situation about which appropriate authorities are interested;
determining a nature of the situation based on the notification message;
determining a location from which the notification message was sent; and
sending an alert message to the appropriate local authorities having an interest in the situation.

29. The method of claim 28, wherein the notification message comprises an image.

30. The method of claim 28, wherein the appropriate authorities include law enforcement authorities.

31. The method of claim 28, wherein the appropriate authorities include fire department personnel.

32. The method of claim 38, further comprising awarding a reward to the Mobile Subscriber for submitting the notification message.
